(19) United States
(12) Patent Application Publication
(10) Pub. No.: US 2013/0333490 A1
(43) Pub. Date: Dec. 19, 2013

(54) Sample Data Processing Device for Analysis Instrument, Autosampler, Liquid Chromatograph Instrument, Sample Data Processing Method, and Analysis Method

(71) Applicant: Toyoaki Tanoue, Hitachinaka (JP)

(72) Inventor: Toyoaki Tanoue, Hitachinaka (JP)

(73) Assignee: Hitachi High-Technologies Corporation, Minato-ku, Tokyo (JP)

(21) Appl. No.: 13/983,390

(22) PCT Filed: Feb. 14, 2012
(86) PCT No.: PCT/JP12/53357

§ 371 Date: Aug. 2, 2013

(30) Foreign Application Priority Data
Mar. 3, 2011 (JP) 2011-046456

(51) Int. Cl. G01N 1/10; G06T 7/00

(52) U.S. Cl. CPC G01N 1/10; G06T 7/004
USPC 73/863.01; 348/135

(57) ABSTRACT

An image capture device is installed in an autosampler and captures an image data of a rack on which one or more vials are disposed. A data processing device analyzes the data captured by the image capture device and acquires information on a position at which the vial is disposed, and sample information attached to each of the vials, in association with each other. The data processing device constructs an optimum analysis program from the acquired vial position information and sample information, and an analysis condition set and inputted by an operator via an input device. The position of the vial and the sample information can be determined in a short period of time, because the position of the vial and the sample information is determined from the image data acquired by capturing an entire image of the rack with the vials disposed thereon.

### CROSS REFERENCE TO RELATED APPLICATION

This application is a National Stage Application of PCT/JP2012/053357, filed on Feb. 14, 2012, and which application is incorporated herein by reference. To the extent appropriate, a claim of priority is made to the above disclosed application.

### TECHNICAL FIELD

The present invention is related to a sample data processing device for an analysis instrument such as a liquid chromatograph instrument, and a sample data processing method.

### BACKGROUND ART

In a conventional technology, it is necessary for an operator to associate information on each of samples arranged in an analysis instrument such as a liquid chromatograph instrument, with an arranged position of each of the samples, and then set an analysis program suitable for each of the samples.

In light of the above, a technique has been known which reduces time and work for the setting and prevents an error in an analysis accompanying the setting as follows. An analysis condition and an analysis program corresponding to sample identification information (ID) are stored in the analysis instrument or an external storage unit. The ID information is given to a vial disposed in the analysis instrument, using a bar code or an IC tag. When the sample is analyzed, the ID information is read. Then, the analysis can be performed based on the analysis condition and the analysis program corresponding to the read ID information (see Paten Document 1: Japanese Laid-Open Patent Application, Publication No. 2005-257548).

### RELATED ART DOCUMENT

### Patent Documents

Paten Document 1: Japanese Laid-Open Patent Application, Publication No. 2005-257548

### SUMMARY OF THE INVENTION

### Problem to be Solved by the Invention

In such an analysis method according to the conventional technology, an operator places a vial in which a sample is put, on a sample rack before conducting an analysis. Upon the analysis, the operator needs to specify a position of a sample to be analyzed and then perform the analysis of the specified sample. For that purpose, the operator is required to manage information on a sample or a position of a vial containing the sample on a sample rack, in addition to an actual analysis.

In some cases, the operator may put a vial at a wrong position or put vials in a wrong order. This may result in an analysis conducted under an erroneous analysis condition.

Even in a case where ID information is attached to a vial using a bar code or an IC tag, it is necessary to appropriately move a detection sensor over the vial and acquire information on a position thereof or ID information one by one.

In the above case, after the ID information of all the vials is read one by one, if one or more vials on the rack are replaced by new ones, another scanning of the vials for reading the ID information becomes necessary. This may increase an overall analysis time.

The present invention has been made in an attempt to provide: a sample data processing device for an analysis instrument capable of reducing time and work required for a setting of an analysis condition or the like of a sample which is performed prior to an actual analysis of the sample, and also capable of preventing an erroneous analysis; and a sample data processing method.

### Means for Solving the Problem

To achieve the attempt, the present invention is configured as follows. In a sample data processing device for an analysis instrument and a sample data processing method of the present invention, a two-dimensional image of a rack for vials in which one or more vials are disposed is captured by an image capture unit; a position of the vial disposed on the rack for vials and sample information recorded in a sample information recording medium attached to the vial are determined based on the captured two-dimensional image of the rack for vials; the two-dimensional image data, as well as the position of the vial on the rack for vials and the sample information are stored; and the stored position of the vial on the rack for vials and the sample information are outputted to outside.

### Advantageous Effects of the Present Invention

The present invention can realize: a sample data processing device for an analysis instrument capable of reducing time and work required for a setting of an analysis condition or the like of a sample which is performed prior to an actual analysis of the sample, and also capable of preventing an erroneous analysis; and a sample data processing method.

### BRIEF DESCRIPTION OF THE DRAWINGS

FIG. 1 is a schematic block diagram illustrating an example of a sample analysis instrument such as a liquid chromatograph instrument to which the present invention is applied, according to an embodiment of the present invention.

FIG. 2 is a partially broken perspective diagram of the example of FIG. 1.

FIG. 3 is a diagram illustrating an example of an upper surface and a side surface of a vial according to the embodiment of the present invention.

FIG. 4 is an operational flowchart illustrating a method of constructing and presenting an analysis program which takes the shortest time to complete the analysis according to the embodiment of the present invention.

FIG. 5 is a diagram illustrating an example of a display screen displayed in accordance with the operational flowchart shown in FIG. 4.

FIG. 6 is a diagram illustrating an example of another display screen displayed in accordance with the operational flowchart shown in FIG. 4.

FIG. 7 is a diagram illustrating an example of a yet another display screen displayed in accordance with the operational flowchart shown in FIG. 4.

FIG. 8 is an operational flowchart of a method of searching a sample satisfying a condition set by an operator and analyzing the found sample according to the embodiment of the present invention.

FIG. 9 is a diagram illustrating an example of a display screen displayed in accordance with the operational flowchart shown in FIG. 8.

FIG. 10 is a diagram illustrating an example of another display screen displayed in accordance with the operational flowchart shown in FIG. 8.

FIG. 11 is a diagram illustrating an example of a yet another display screen displayed in accordance with the operational flowchart shown in FIG. 8.

FIG. 12 is an inner function block diagram illustrating a data processing device according to the embodiment of the present invention.

FIG. 13 is an operational flowchart illustrating a processing of reading a position of the vial on a rack and sample information according to the embodiment of the present invention.

FIG. 14 is a diagram illustrating an example of the rack according to the embodiment of the present invention.

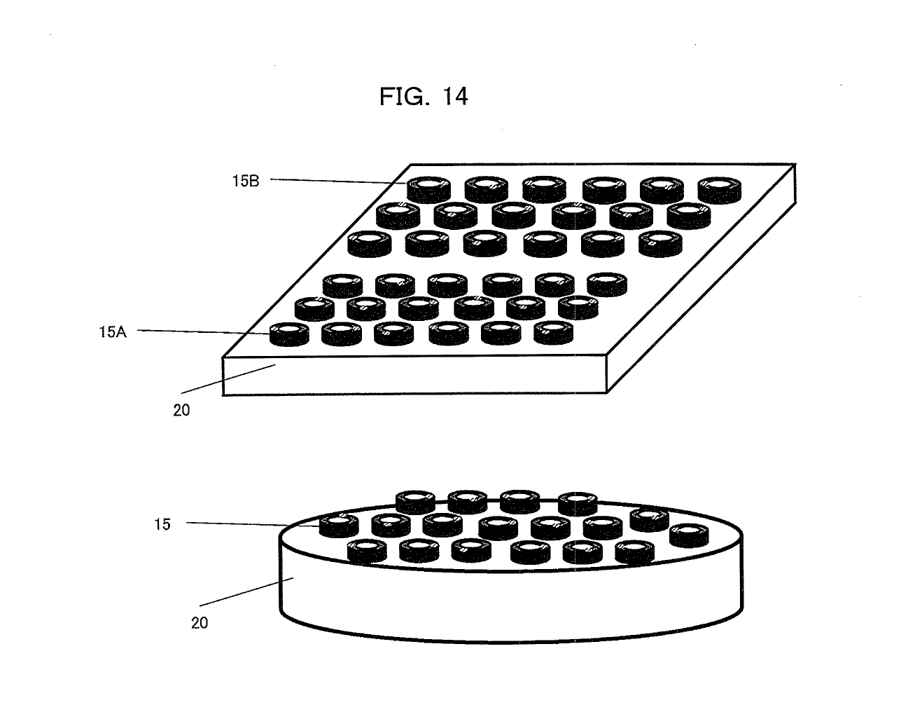

FIG. 15 is a diagram illustrating an example of a display screen displayed when a sample to be used is selected, according to the embodiment of the present invention.

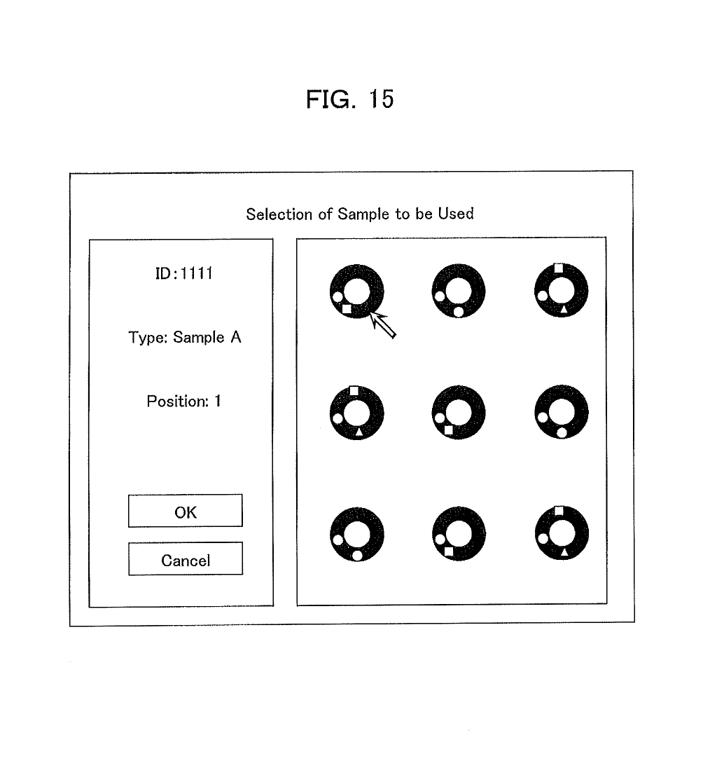

FIG. 16 is an operational flowchart illustrating a processing of automatically preparing a standard curve and analyzing an unknown sample based on a marker in which sample information is registered, according to the embodiment of the present invention.

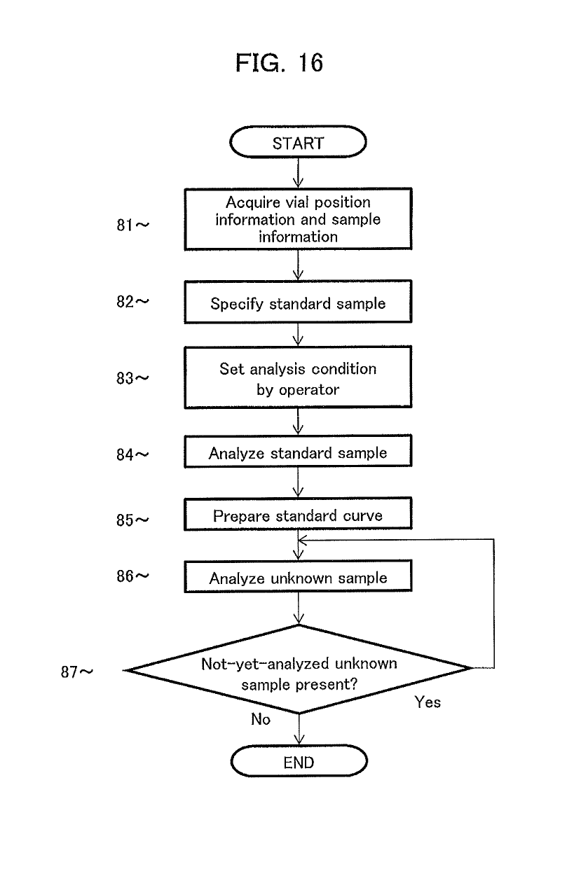

FIG. 17 is an operational flowchart illustrating a processing of automatically registering sample information in a marker, preparing a standard curve from the registered marker, and analyzing an unknown sample, according to the embodiment of the present invention.

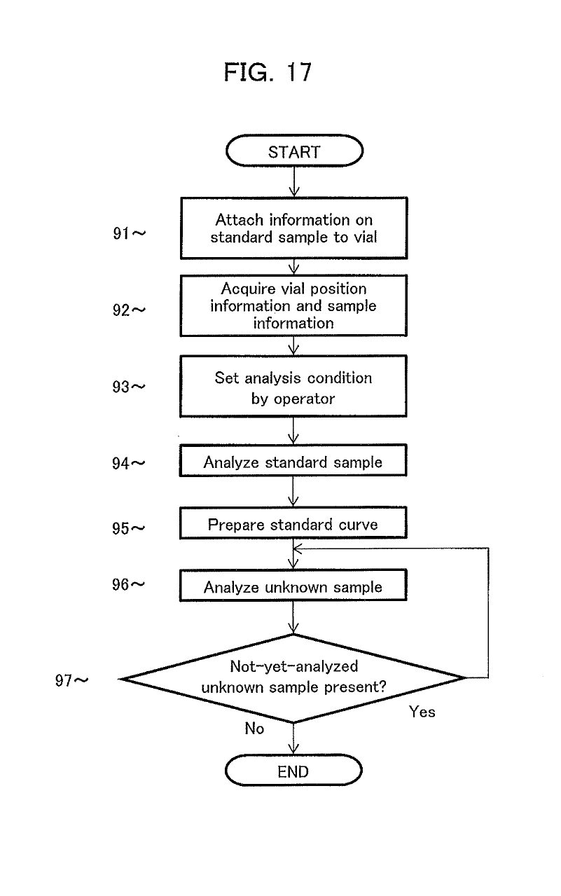

FIG. 18 is an operational flowchart illustrating a processing of registering a shape of the rack based on the marker in which sample information is registered, according to the embodiment of the present invention.

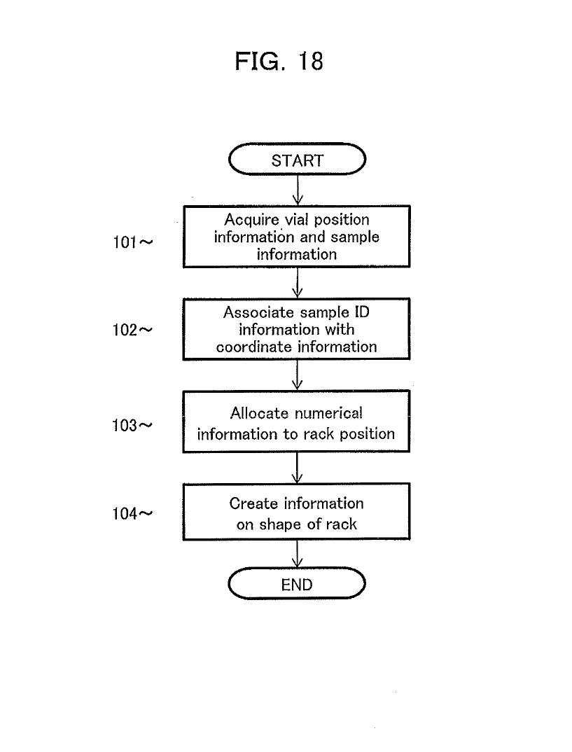

FIG. 19 is a diagram illustrating an example of a display screen displayed in accordance with the operational flowchart shown in FIG. 18.

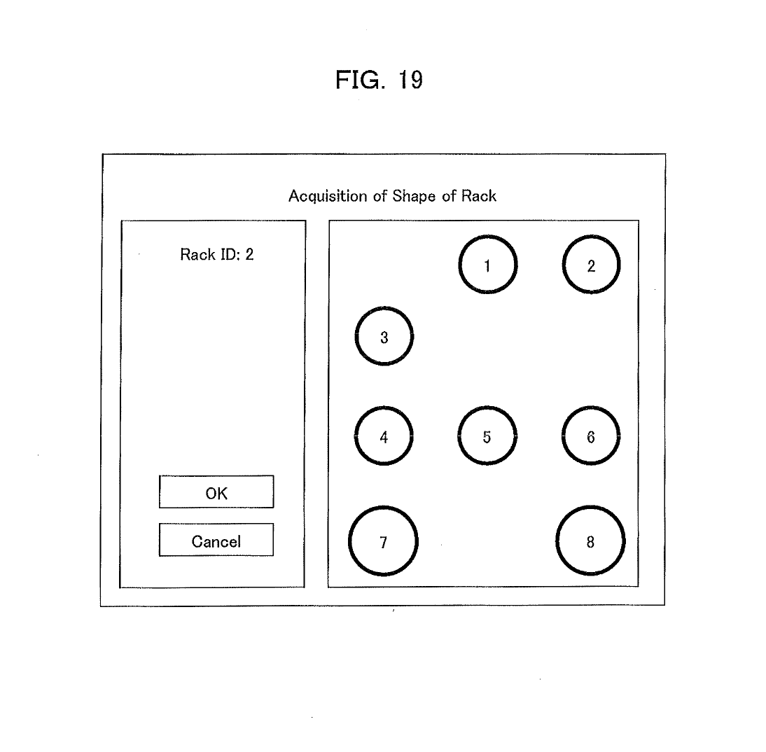

### EMBODIMENT FOR CARRYING OUT THE INVENTION

Next is described in detail an embodiment of the present invention with reference to accompanied drawings.

### Embodiment

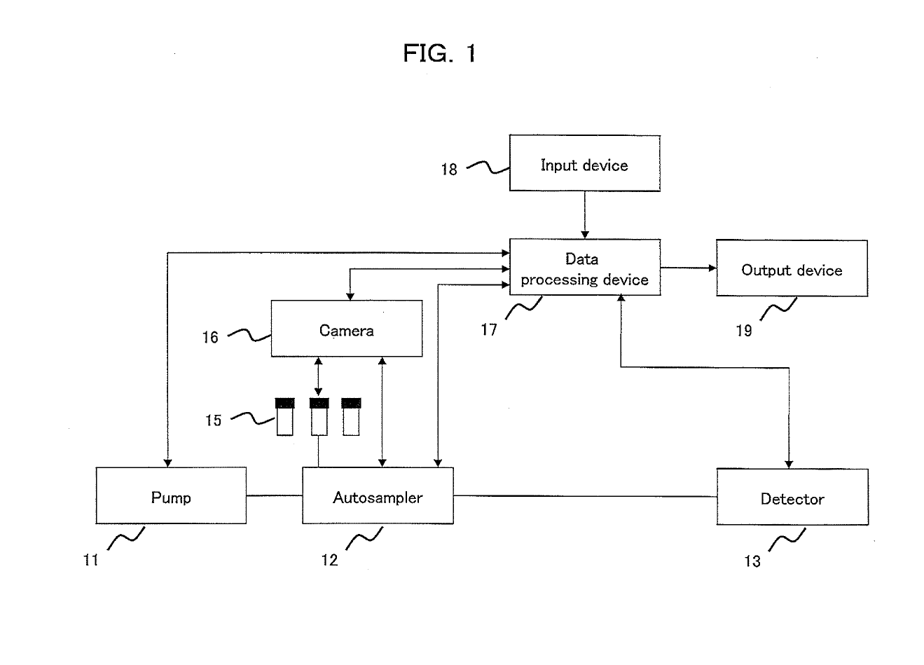

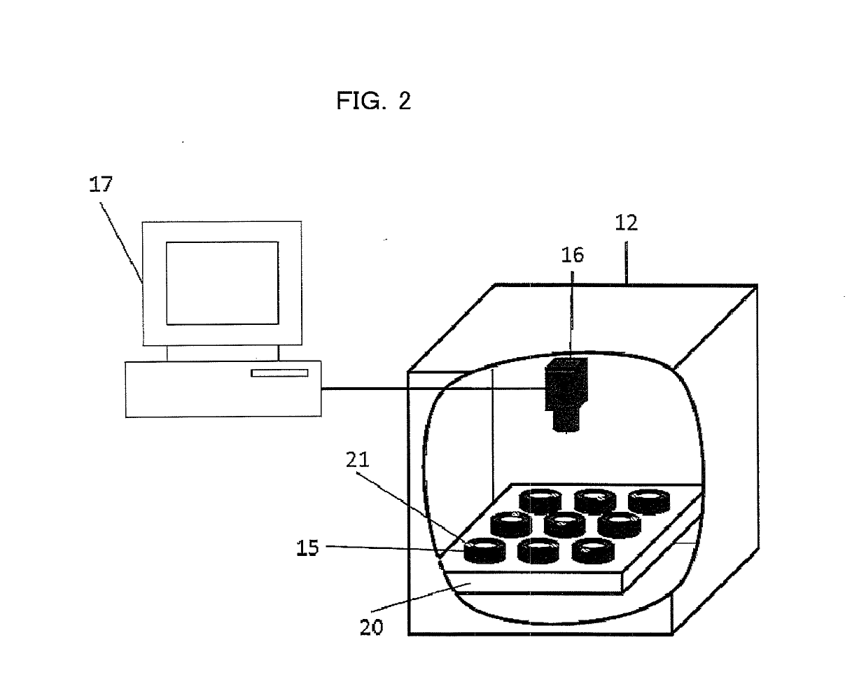

FIG. 1 is a schematic block diagram illustrating an example of a sample analysis instrument such as a liquid chromatograph instrument to which the present invention is applied, according to an embodiment of the present invention. FIG. 2 is a partially broken perspective diagram of the example of FIG. 1.

In FIG. 1 and FIG. 2, an image capture device (which may also be referred to as a camera) 16 is installed in an autosampler (an autosampler) 12 and captures (images) an image data (a two-dimensional image data) on a rack 20 on which one or more vials 15 each containing therein a sample are disposed. A data processing device 17 analyzes the data captured by the image capture device 16 and acquires therefrom information on a position at which the vial 15 is disposed and information on the sample which is attached to the vial 15, in association with each other. The sample information is recorded in a sample information recording medium attached to each of the one or more vials 15.

The data processing device 17 constructs an optimum analysis program based on the acquired vial position information and sample information as well as an analysis condition set by the operator via the input device 18. The data processing device 17 presents the optimum analysis program to the operator via the output device 19 and analyzes the sample.

A pump 11 is used for mixing a reagent or an eluent with a sample sampled by the autosampler 12. A detector 13 then detects a component contained in the sample, which is analyzed by the data processing device 17.

Note that the data processing device 17 can be configured to just output a data detected by the detector 13 to an other analysis unit (not shown) without analyzing the component detected by the detector 13.

The image capture device 16 in the autosampler 12 is installed at a position from which an image data of the entire rack 20 can be captured from above.

Next is described an analysis of an image captured by the image capture device 16.

An image data of the entire rack 20 is acquired beforehand when the vial 15 has not yet been disposed therein, as a reference image data, and the reference image data is stored in the data processing device 17. After the vial 15 is arranged on the rack 20, a preprocessing such as gray scale processing and smoothing is performed to an image captured after the arrangement, as well as to the stored reference image. A difference image is then created between the reference image data and the image data acquired after the arrangement.

A position of the vial 15 disposed on the rack 20 and a position of a portion corresponding to the sample information attached to the vial 15 are extracted from the acquired difference image. The sample information is read from the portion to which the extracted sample information is attached. The sample information is stored in association with the position of the vial 15.

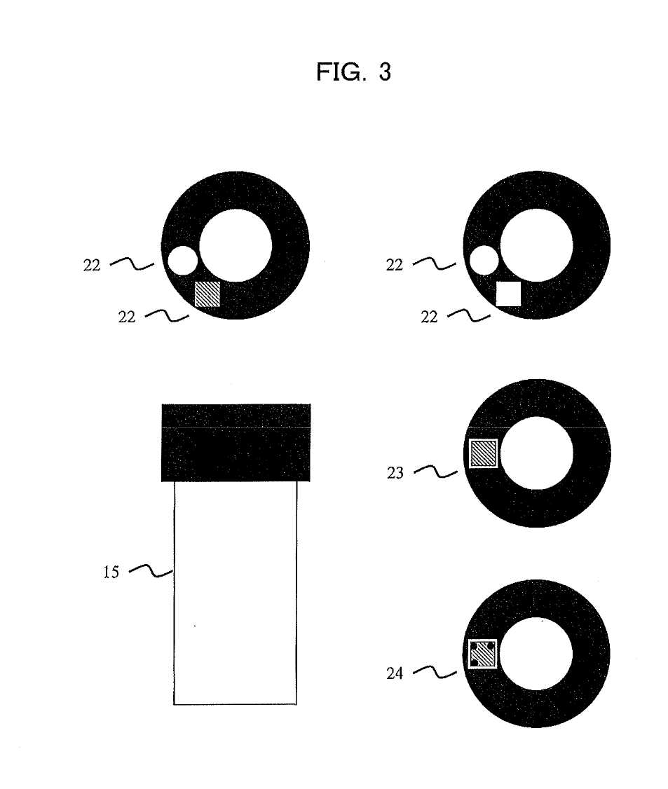

The sample information is attached to the vial 15 by attaching to an upper surface of a lid of the vial 15 using a marker 21. The marker 21 used in the embodiment of the present invention includes, as shown in FIG. 3, a bar code 23, a QR code (registered trademark) 24, a mark indifferent color 22, a mark in different shape 22, a numeric character, an alphabetical character, and any others which can be captured as an image and by which a difference between a plurality of the sample information can be distinguished from each other.

When the image capture device 16 captures an image from above the rack 20, a difference between the sample information is displayed on a display of the data processing device 17.

The information given by the marker 21 includes a date, a type of a sample, an ID number, the number of times of available injections, and a default value of a washing time. Those items are used when an operator determines an analysis condition or manages the analysis, or are required for determining the order of a serial analysis.

If the data processing device 17 has information on a shape of the vial 15, the above-mentioned difference image can be subjected to template matching or the like, to thereby remove the image of the vial 15 from the difference image. Information on a foreign object which is different from the vial 15 can also be acquired.

In preparation for a liquid leak from the vial 15 or a pipe, by any chance, a geometric pattern can be put at a position of the reference image data over which liquid may possibly flow. In a case where a liquid leak actually occurs, because the liquid causes a difference in data of the pattern before and after the leakage, the difference image makes it possible to detect the liquid leak. Even if the leaked liquid is transparent, because the pattern becomes distorted due to refraction, the difference image can detect the liquid leak.

Next are described some examples of how to use information of various types acquired using the marker 21.

(1) Method of Constructing and Presenting Analysis Program Taking the Shortest Time for Automatic Continuous Analysis

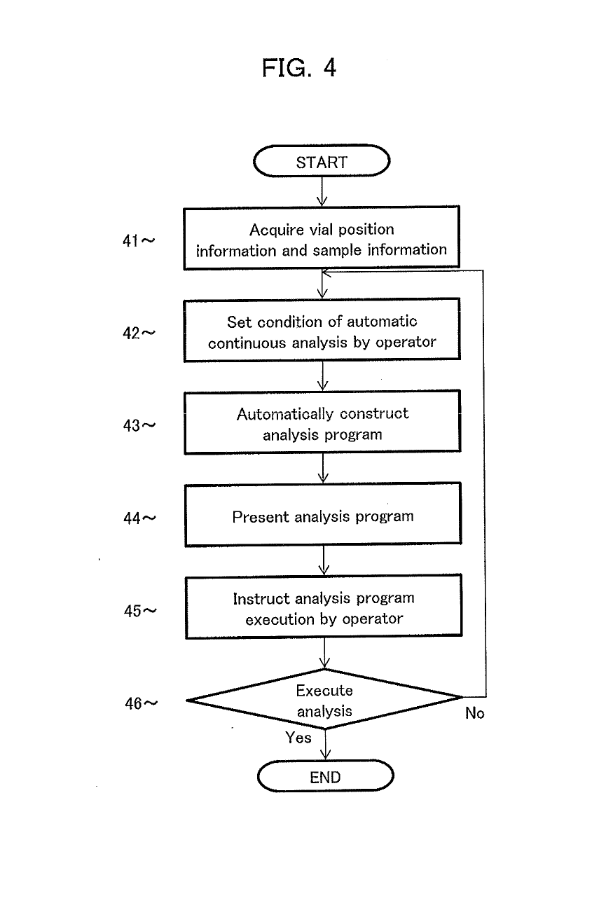

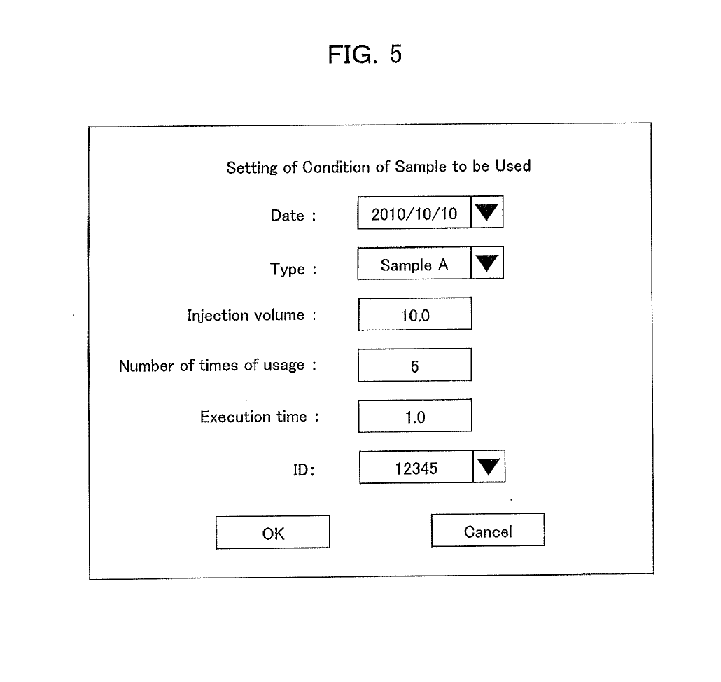

FIG. 4 is an operational flowchart illustrating a method of constructing and presenting an analysis program which takes the shortest time to complete an automatic continuous analysis. FIG. 5 to FIG. 7 are each an example of a display screen displayed in the output device 19 which serves as the display unit.

In step 41 of FIG. 4, the data processing device 17 acquires the vial position information and sample information on the rack 20, based on image information (entire image information of the rack 20) from the camera 16.

In step 42, as shown in FIG. 5, a display screen for setting a condition of a sample to be used is displayed in the output device 19. An operator can set a condition of an automatic continuous analysis including items registered in the marker 21, using the display screen shown in FIG. 5. For example, if the marker 21 contains an item of information on a type of the sample, the operator can set a type of the sample to be analyzed, by making a conditional expression in terms of the type of the sample.

In step 43, the data processing device 17 constructs an analysis program which takes the shortest time to complete the analysis. A method of constructing an analysis program taking the shortest time to complete the analysis is obtained by, for example, simulation of a possible combination of operations of an injection mechanism which takes the shortest time from a start to an end of an analysis within a restriction that the conditional expression including an item registered in the marker 21 set by the operator is satisfied. Note that, due to a washing time or a condition set by an operator, a travel distance of the injection mechanism is not necessarily the shortest.

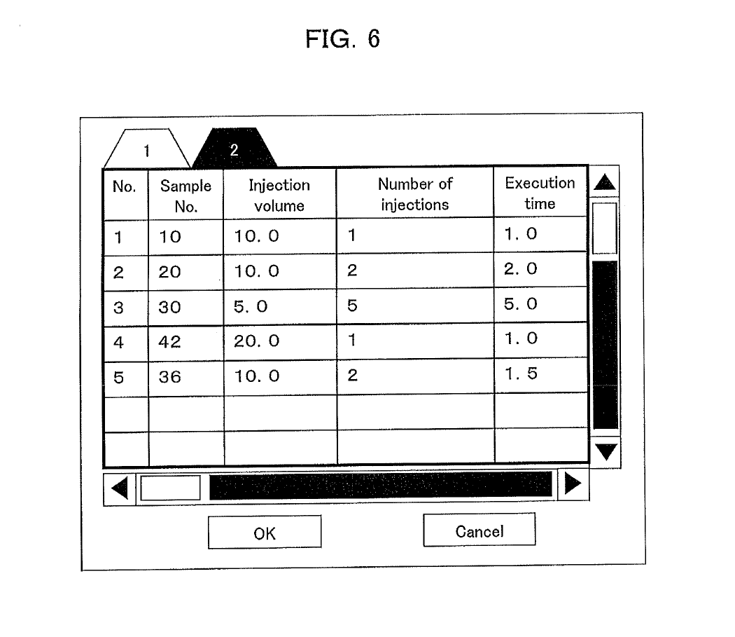

In step 44, the constructed analysis program is displayed in the output device 19. FIG. 6 illustrates a display example of the constructed analysis program.

When the constructed analysis program is presented in the output device 19 which serves as the display unit, a position of the vial 15 or a condition used for the setting, or even any other information not used for the setting may also be displayed.

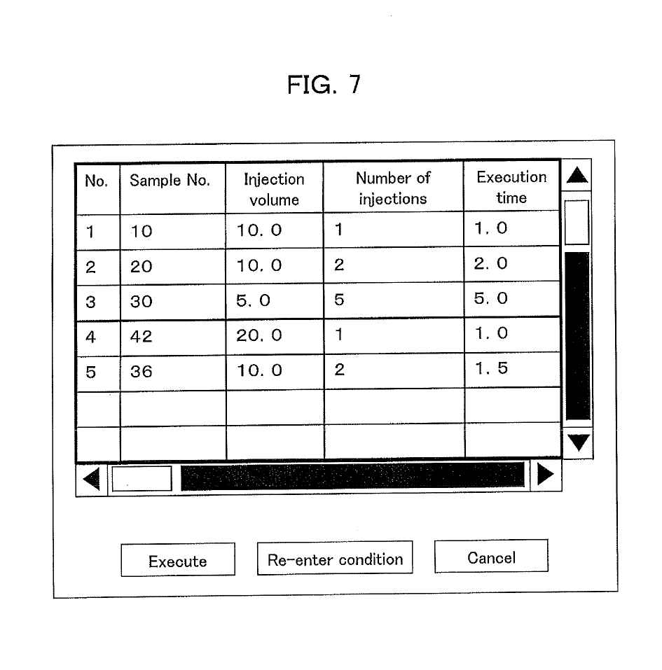

The analysis program presented in the display unit makes it possible for the operator to determine whether or not the analysis is executed or stopped or whether or not the analysis program is reconstructed by adding or deleting an appropriate condition. In steps 45 and 46, the operator instructs an analysis program execution and an analysis corresponding thereto via the display screen shown in FIG. 7. If the operator wants to re-enter a condition in step 46, the operator instructs so to the data processing device 17 via the display screen shown in FIG. 7, and the processing returns to step 42.

By using the method, the analysis and the control of the samples can be performed efficiently. An error can be prevented in arrangement and setting of the vials 15, because it is not necessary for the operator to arrange the vials 15 in order and specify the positions thereof.

(2) Method of Searching Sample Satisfying Condition Set by Operator and Analyzing Found Sample

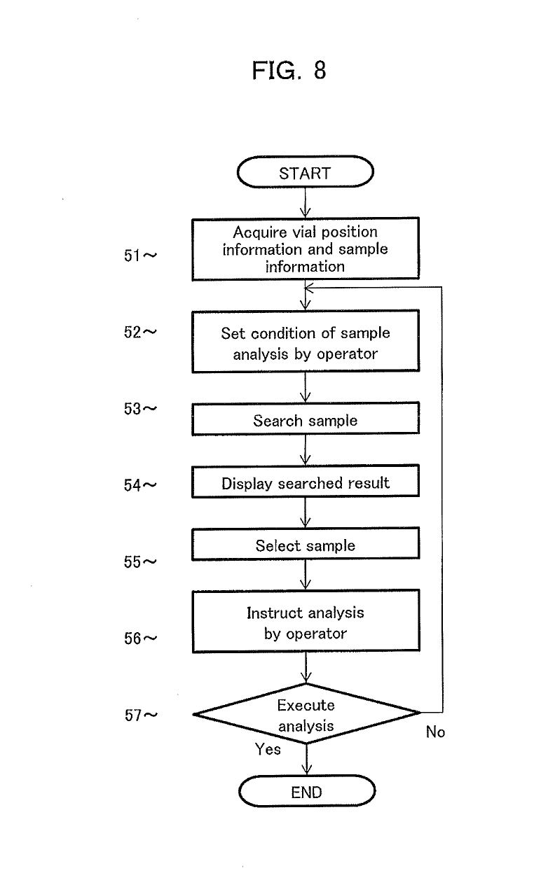

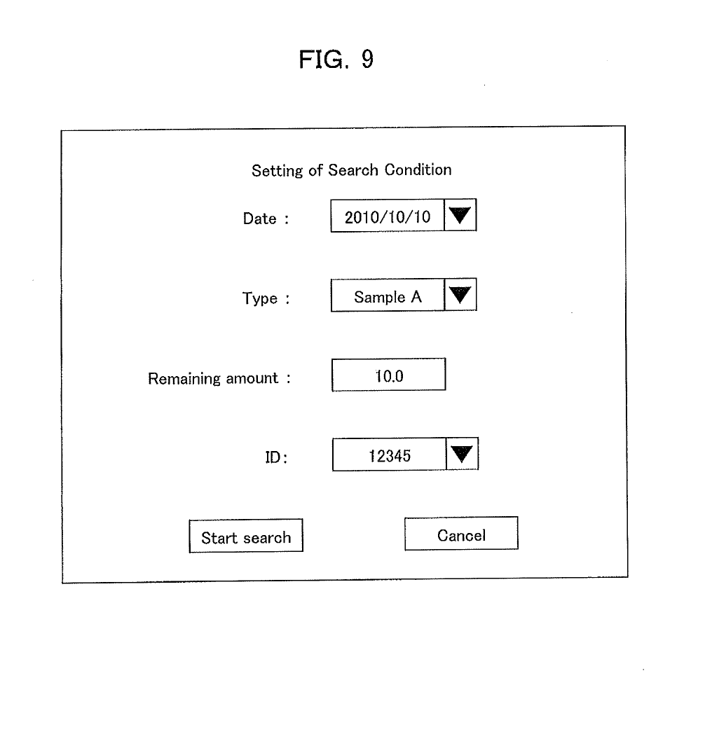

FIG. 8 is an operational flowchart illustrating a method of searching a sample satisfying a condition set by the operator and analyzing the found sample. FIG. 9 to FIG. 11 are diagrams each illustrating an example of a display screen displayed in the display unit which herein corresponds to the output device 19.

The operator sets a start of an analysis with a certain condition in the data processing device 17 via the input device 18. Then, in step 51, the data processing device 17 acquires the position information of the vials 15 disposed on the rack 20 and the sample information from information obtained by the camera 16.

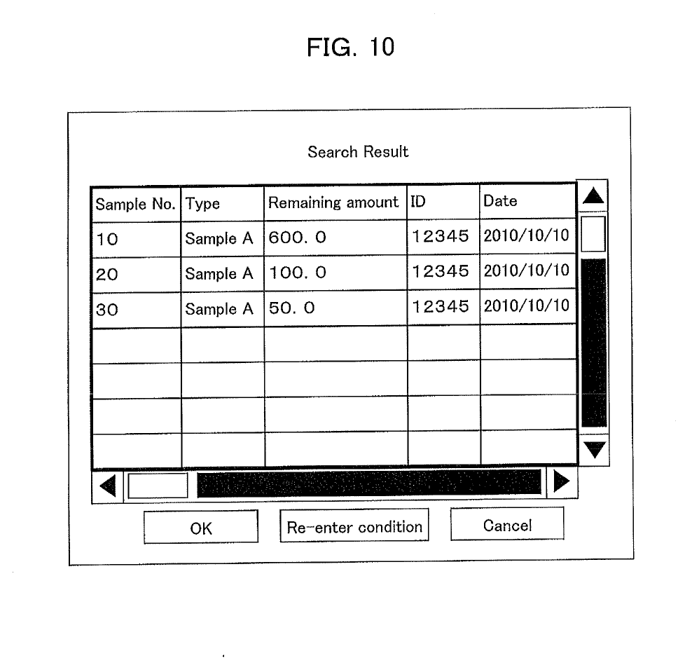

In step 52, the data processing device 17 makes the output device 19 display a search condition setting screen shown in FIG. 9. The operator sets a sample condition by operating the screen displayed in the output device 19. In step 53, a sample which meets the set condition is searched from the stored sample. In step 54, the sample information as the searched result is screen displayed as shown in FIG. 10.

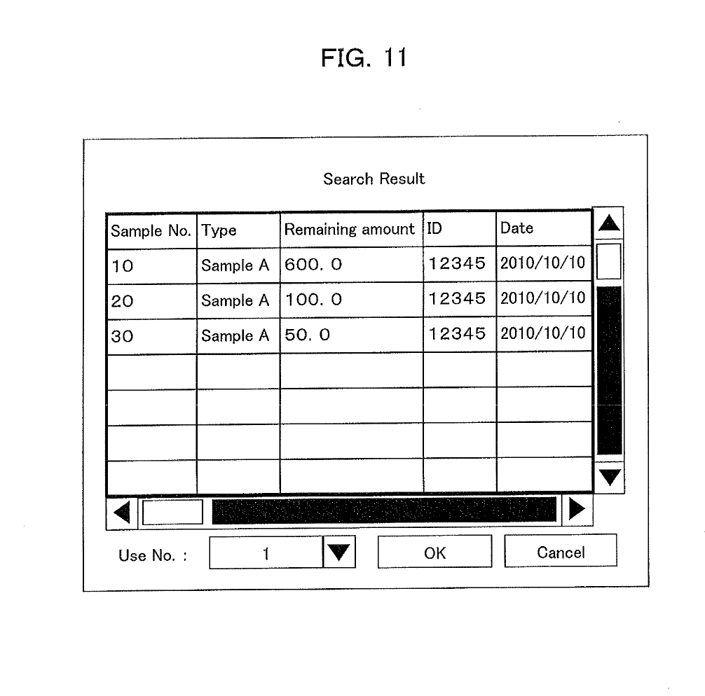

In step 55, the operator selects an appropriate sample. The selected result is screen displayed as shown in FIG. 11. In step 56, the operator gives an instruction of an analysis of the selected sample via the display screen. In step 57, if the instruction indicates an execution of the analysis, the analysis is executed. And if not, the processing returns to step 52.

Note that, if there is no sample which satisfies the condition, the operator is notified so by a screen display of an appropriate message.

It is also possible to display a list of information held by the data processing device 17, from which the operator can make a setting.

By using the above-described searching method, the control of the samples can be performed efficiently.

(3) Method of Issuing Warning about Detected Abnormal State and Placing Operation Restriction

The data processing device 17 issues a warning to the output device 19 and restricts an operation of the sample analysis instrument for safety, when any of the following is detected: information on a foreign object on the rack 20; information on a liquid leak; and information on whether or not the vial 15 is present at a position specified by the operator, or when the operator specifies so in the above-described methods (1) or (2). For example, the rack 20 has a rack number (a number of a layout position of the vial in the rack 20). Assume a case in which an operation of the analysis or the like is performed upon specifying the rack number by the operator. If a rack number is specified but no vial is present on the rack 20 having the specified number of the autosampler 12, the output device 19 issues a warning by displaying that the rack number is not available and prompting the operator to set the rack number again. Until the rack number is re-set, the data processing device 17 performs an operation restriction such as restricting an operation of a sample injection from a vial.

Note that such a processing of restricting a sample injection operation can be used as an auxiliary or a substitute means of a sensor for use in detecting a liquid leak or a foreign object in the related art.

The information on whether or not the vial 15 is present includes, if the vial 15 is present, information on a position of the vial 15 which has been previously stored therein, unlike the conventional technology. This eliminates a need of actually operating the analysis instrument. By using the above-described method, efficiency of the analysis and safety of the instrument can be improved.

(4) Method of Supporting Rack Parameter Setting by Displaying Image on the Rack 20

A screen display of an image on the rack 20 captured by the image capture device 16 allows the operator to know a state of the inside of the autosampler 12 as viewed from directly above. This can help the operator make a setting even when the inside of the autosampler 12 is dark and is difficult for the operator to look in.

Also, because the image on the rack 20 is analyzed, when a mechanism for an injection operation is driven, whether or not the mechanism for an injection operation comes into contact with the rack 20 or the vial 15 can be detected beforehand. A warning can be thus given to the operator.

Next is described an inner function of the data processing device 17.

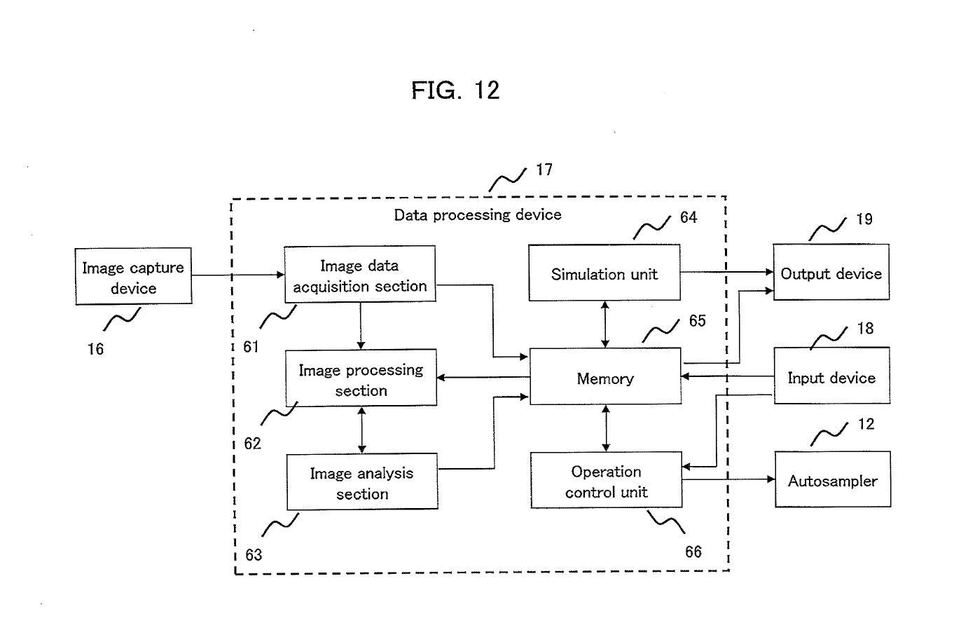

FIG. 12 is an inner function block diagram illustrating the data processing device 17. In FIG. 12, the data processing device 17 includes an image data acquisition unit 61, an image processing section 62, an image analysis section 63, a simulation unit 64, a memory (a storage unit) 65, and an operation control unit 66.

The image data acquisition unit 61 acquires a data captured by the image capture device 16 and transmits the acquired image data to the memory 65. The image data acquisition unit 61 transmits the acquired image data also to the image processing section 62.

The image processing section 62 performs an image processing such as a gray scale processing and smoothing, to the image data transmitted from the image data acquisition unit 61. The processing section 62 then compares the image subjected to the smoothing or the like, with the reference image stored in the memory 65.

The image analysis section 63 analyzes the image data transmitted from the image processing section 62 and thereby determines a position of a vial, information on a reagent, a liquid leak, or the like. The determination result by the image analysis section 63 is transmitted to the memory 65.

The operation control unit 66 controls an operation of the autosampler 12 according to the position of the vial stored in the memory 65, the sample information, contents instructed from the input device 18, and the like.

The simulation unit 64 runs a simulation in step 43 shown in FIG. 4, using the data stored in the memory 65. The simulation result is transmitted from the simulation unit 64 to the output device 19.

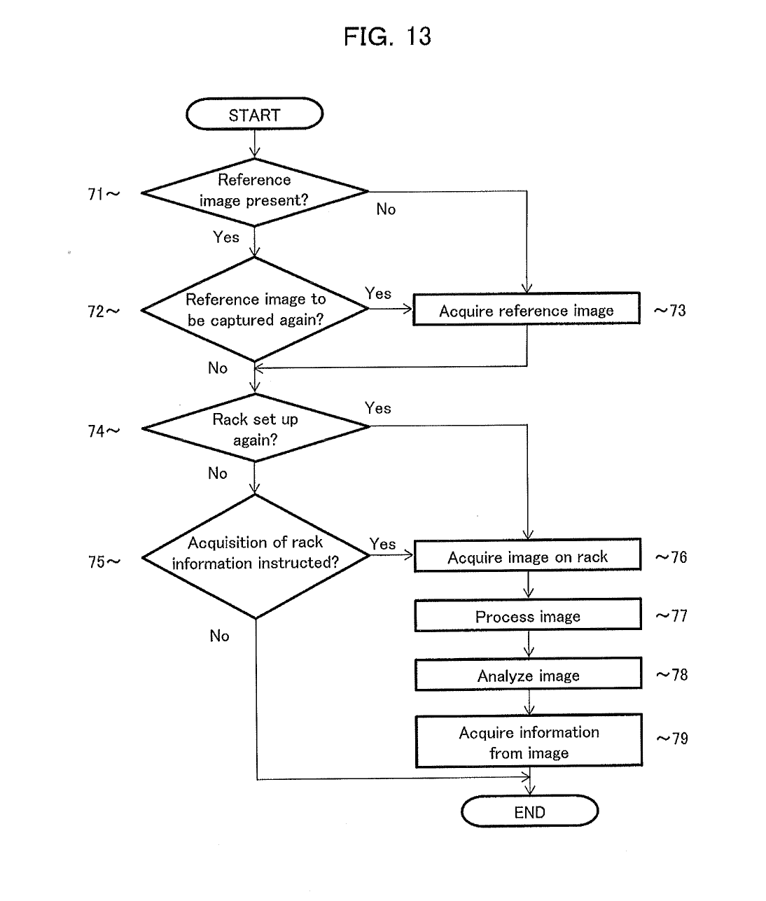

FIG. 13 is an operational flowchart illustrating a processing of reading a position of the vial 15 on the rack 20 and sample information according to the embodiment of the present invention.

In step 71 of FIG. 13, if no reference image is determined to be present in the memory 65, the reference image is captured in step 73 and the processing advances to step 74. In step 71, if the reference image is determined to have been stored in the memory 65, it is determined whether or not the reference image is to be captured again in step 72. If the reference image is determined to be captured again, the processing advances to step 73.

In step 72, if the reference image is not determined to be captured again, the processing advances to step 74. In step 74, it is determined whether or not the rack 20 has been set up in the autosampler 12 again. The determination can be made using the image information from the image capture device 16. Or, when the rack 20 has been set up again, the autosampler 12 can be configured to notify the data processing device 17 of the re-set.

In step 74, if the rack 20 is not determined to have been set up again, the processing advances to step 75. It is then determined whether or not acquisition of the rack information is instructed. If acquisition of the rack information is not determined to be instructed, the processing terminates.

In step 74, if the rack 15 is determined to have been set up again, and if acquisition of the rack information is instructed in step 75, the processing advances to step 76.

In step 76, the image data acquisition unit 61 acquires the image on the rack 20 from the image capture device 16. In step 77, the image processing section 62 performs an appropriate image processing to the acquired image. In step 78, the image analysis section 63 analyzes the image. In step 79, sample information is acquired from the image.

As described above, the data processing device 17 reads the position of the vial 15 on the rack 20 and the sample information and stores the both information in the memory 65.

As mentioned above, according to the embodiment of the present invention, the image capture device 16 captures an entire image of the rack 20 on which one or more vials 15 are disposed is captured, and a position of the vial 15 and information on the vial 15 of interest are determined based on an image data obtained from the captured image. This makes it possible to determine the position of the vial 15 and the sample information of interest in a short period of time.

That is, it is not necessary for the operator to enter data on a position and sample information for each of the vials 15 arranged on the rack 20, in the analysis instrument.

Further, a time required for the determination can be drastically reduced, compared to a configuration in which the vials 15 arranged on the rack 20 are scanned one by one using a detection sensor and a position or other information of the vial 15 is then determined.

Hence, the embodiment of the present invention can provide: the sample data processing device for the analysis instrument capable of reducing time and work necessary for a setting of an analysis condition of a sample or the like which is performed prior to an analysis of the sample, and also capable of preventing an erroneous analysis; and the sample data processing method.

Note that, in FIG. 12, the data processing device 17 is configured to include the operation control unit 66 and make the operation control unit 66 control an operation of the autosampler 12. However, the data processing device 17 may be configured to not include the operation control unit 66 but include an output unit that outputs the image analysis data stored in the memory 65, the sample information, and the captured image data, to the outside. In this case, the autosampler 12 is configured to include therein the operation control unit 66.

The present invention can be applied not only to the case as described in the embodiment but also to a case in which information on fractions of samples of many different types is managed or utilized.

That is, the present invention can be applied not only to the liquid chromatograph instrument but also to a vial information readout device of an automatic analysis instrument, in which samples are arranged on a vial rack. The present invention is also applicable to a single autosampler used in an analysis instrument. Such an autosampler includes the rack 20, the camera 16, the data processing device 17, the input device 18, and the output device 19.

(5) Method of Creating and Presenting Sample Table Based on Sample Information and Rack Position Information of Sample

The operator makes a setting of a condition of a sample table including an item registered in the marker 21. For example, if the marker 21 includes such sample information as an ID number of a sample, a type thereof, and an initial content thereof, the operator makes a conditional expression in terms of the type of the sample by setting an appropriate type of the sample subjected to an analysis, via the input device 18.

The data processing device 17 controls samples by updating an ID number of each of the samples, a position at which the sample is arranged, and a current amount of the sample starting from an initial content and a remaining amount each time the sample is injected. An example of a method of creating the sample table is as follows: as long as a conditional expression including an item registered in the marker 21 set by the operator is satisfied, the data processing device 17 computes the vial 15 to which an injection can be performed, based on the type of the sample, the number of times of available injections, and a set injection volume, and presents a rack position to which an injection is to be performed, to the sample table; and the operator determines, based on the presented sample table, whether or not the sample table requires no change, or whether or not the sample table requires to be re-created by adding or deleting a condition. By using the method, the sample table can be created and the samples can be controlled efficiently. An error can also be prevented in arranging the vials 15 and in making a setting when an operator manages a sample, because it is not necessary for the operator to arrange the vials 15 in order, recognize in which position each of the vials 15 is placed, and specify the positions thereof.

(6) Method of Handling Desired Vial and Rack Based on Two-Dimensional Image Data of Rack for Vials

Information on an ID number is given to the marker 21. The image capture device 16 captures a layout position of the vials 15 on the rack 20, as a two-dimensional image, based on the information on the ID number. A position at which the vial 15 is placed is extracted from the captured image. The image is associated with information on a coordinate of the position. The data processing device 17 automatically allocates numerical information to the position, thus allowing information on a shape of the rack 20 to be captured. With this configuration, if the rack 20 has a structure capable of fixing a position of the vial 15, the rack 20 having any shape can be used. At the same time, image information of each of the vials 15 can be acquired from the two-dimensional image. This makes it possible to use the vial 15 regardless of the shape or size thereof. Note that the information on coordinates can be obtained by using such a method that the image capture device 16 acquires a two-dimensional image captured at a reference position directly above the rack 20 and calculates the information on coordinates from coordinates of the captured image. However, if more than one marker 21 of the same type is present, a warning is presented to the operator indicating the duplication of the markers 21 and the positions of the duplicated vials 15. Further, in setting which vial 15 is to be used, two pieces of information, namely, the two-dimensional image and the coordinate, are herein obtained as a position in which the vial 15 on the rack 20 is disposed. This makes it possible to use not only a generally known method in which a number indicating a position of the vial 15 is set, but also another method in which: the two-dimensional image containing the position at which the vial 15 on the rack 20 is disposed is presented to the operator; and the operator selects the vial 15 to be used from the two-dimensional image.

(7) Method of Using Marker and Information on Vial in Association with Each Other Based on Two-Dimensional Image Data on Rack for Vial

If a shape of the rack 20 to be used matches a pattern registered in the autosampler 12 to be used, the data processing device 17 associates the generally-used rack position information with the ID number information acquired from the two-dimensional image as described in (6) using the coordinate information or the like. With this configuration, when it is necessary to know a position of the vial 15 in setting a position for an injection or the like, the operator can make an appropriate setting by selecting the position of the vial 15 from both the rack number indicating a position of the rack 20 and the ID number attached to the vial 15.

(8) Method of Automatically Preparing Standard Curve and Analyzing Unknown Sample Based on Marker in which Sample Information is Registered

The marker 21 acquired using the method (6) or a shape of the vial 15, information on a standard sample, and information on an unknown sample are associated with each other. A standard curve is prepared using a sample which has been automatically associated as the standard sample. Then, a sample associated as the unknown sample or a sample other than the standard sample is sequentially subjected to an analysis. With this configuration, in such a case as a quality control in which similar analyses are repeatedly performed, the analysis can be carried out regardless of layout of vials.

### DESCRIPTION OF REFERENCE CHARACTERS

11 pump
12 autosampler
13 detector
15 vial
16 image capture device
17 data processing device
18 input device
19 output device
20 rack
21 marker
22 mark in different color or shape
23 bar code
24 QR code
61 image data acquisition section
62 image processing section
63 image analysis section
64 simulation unit
65 memory
66 operation control unit
15 Å small-sized vial
15B large-sized vial

1. A sample data processing device for an analysis instrument, comprising:
an image capture unit that captures a two-dimensional image of a rack for vials on which one or more vials are disposed;
a data processing unit that determines a position of the vial disposed on the rack for vials and sample information recorded in a sample information recording medium attached to the vial, based on the two-dimensional image of the rack for vials captured by the image capture unit; and
a storage unit that stores therein the two-dimensional image data captured by the image capture unit, as well as the position of the vial on the rack for vials and the sample information determined by the data processing unit,
wherein the position of the vial on the rack for vials and the sample information which are stored in the storage unit are outputted to outside.

2. The sample data processing device for the analysis instrument according to claim 1,
wherein the storage unit stores therein a two-dimensional image data of the rack for vials in which no vial is disposed, as a reference image data, and
wherein the data processing unit compares the reference image data stored in the storage unit, to the two-dimensional image of the rack for vials captured by the image capture unit, and acquires a position at which the vial is disposed on the rack for vials and the sample information recorded in the sample information recording medium.

3. The sample data processing device for the analysis instrument according to claim 2,
wherein the data processing unit: constructs an analysis operation method by which a sample analysis operation performed by the analysis instrument is completed taking the shortest time, based on an analysis condition set in the analysis instrument and the information on the position of the vial on the rack for vials stored in the storage unit; and outputs information on the constructed analysis operation method.

4. The sample data processing device for the analysis instrument according to claim 2, further comprising:
a display unit; and
an input unit to which an operator inputs an instruction,
wherein the rack for vials has a previously-determined rack number which indicates a layout position of the vial, and
wherein the data processing unit: if the operator enters the rack number via the input unit, determines whether or not the vial is present at a position corresponding to the inputted rack number, based on an image captured by the image capture unit; and, if the vial is not present at the position corresponding to the inputted rack number, makes the display unit display a warning.

5. The sample data processing device for the analysis instrument according to claim 2, further comprising;
a display unit; and
an input unit to which an operator inputs an instruction,
wherein the rack for vials has a previously-determined rack number which indicates a layout position of the vial, and
wherein the data processing unit: determines the rack number attached to the rack for vials, based on an image captured by the image capture unit; if the operator enters an analysis condition of a sample via the input unit, searches a sample which satisfies the inputted analysis condition; and makes the display unit display sample information on the found sample.

6. The sample data processing device for the analysis instrument according to claim 2,
wherein the sample information recording medium attached to the vial stores therein information on a reagent using a bar code or a QR code.

7. The sample data processing device for the analysis instrument according to claim 2,
wherein the data processing unit: compares the reference image data stored in the storage unit, to the two-dimensional image of the rack for vials captured by the image capture unit; and determines whether or not there is a liquid leak of a liquid sample from the vial disposed on the rack for vials.

8. An autosampler which samples and supplies a sample to be analyzed to a sample analysis instrument, the autosampler comprising the sample data processing device for the analysis instrument according to claim 1.

9. A liquid chromatograph instrument comprising the autosampler according to claim 8.

10. A sample data processing method for an analysis instrument, comprising the steps of:
capturing a two-dimensional image of a rack for vials on which one or more vials are disposed;
determining a position of the vial disposed on the rack for vials and sample information recorded in a sample information recording medium attached to the vial, based on the captured two-dimensional image of the rack for vials;
storing the two-dimensional image data, as well as the position of the vial on the rack for vials and the sample information; and
outputting the stored position of the vial on the rack for vials and the sample information, to outside.

11. The sample data processing method for an analysis instrument according to claim 10, further comprising the steps of:
storing a two-dimensional image data of the rack for vials in which no vial is disposed, as a reference image data;
comparing the stored reference image data to the captured two-dimensional image of the rack for vials; and
acquiring a position at which the vial is disposed on the rack for vials and the sample information recorded in the sample information recording medium.

12. The sample data processing method for an analysis instrument according to claim 11, further comprising the steps of:
constructing an analysis operation method by which a sample analysis operation performed by the analysis instrument is completed taking the shortest time, based on an analysis condition set in the analysis instrument and the stored information on the position of the vial on the rack for vials; and
outputting the constructed information to outside.

13. The sample data processing method for an analysis instrument according to claim 11,
wherein the rack for vials has a previously-determined rack number which indicates a layout position of the vial,
the sample data processing method further comprising the steps of:
if an operator enters the rack number via the input unit, determining whether or not the vial is present at a position corresponding to the inputted rack number, based on the captured image; and
if the vial is not present at the position corresponding to the inputted rack number, making the display unit display a warning.

14. The sample data processing method for an analysis instrument according to claim 11,
wherein the rack for vials has a previously-determined rack number which indicates a layout position of the vial,
the sample data processing method further comprising the steps of:
determining the rack number attached to the rack for vials, based on the captured image; and
if the operator enters an analysis condition of a sample via the input unit, searching a sample which satisfies the inputted analysis condition and making the display unit display sample information on the found sample.

15. The sample data processing method for an analysis instrument according to claim 11,
wherein the sample information recording medium attached to the vial stores therein information on a reagent using a bar code or a QR code.

16. The sample data processing method for an analysis instrument according to claim 11, further comprising the steps of:
comparing the reference image data to the two-dimensional image of the rack for vials captured by the image capture unit; and
determining whether or not there is a liquid leak of a liquid sample from the vial disposed on the rack for vials.

17. A liquid chromatograph instrument, comprising:
an autosampler that reads sample ID information attached to a vial using a marker and also reads vial position information containing a rack number indicating a position at which the vial is disposed; and
a data processing device that constructs a sample table based on an analysis condition inputted and set from an input unit, the sample ID information on a sample read from the autosampler, and the vial position information, and presents the sample table to an operator.

18. An analysis method using the sample data processing device according to claim 2, comprising the steps of:
holding sample ID information attached to the vial using a marker and an initial content of a sample, in the sample data processing device;
managing a remaining amount of the sample based on a volume already having been used for an injection; and
placing a restriction or issuing a warning when an analysis program or a sample table is created.

19. A liquid chromatograph instrument using the sample data processing device according to claim 8,
wherein the sample ID information attached to the vial using a marker and an initial content of the sample are held in the sample data processing device; a remaining amount of the sample is managed based on a volume already having been used for an injection; and a restriction is placed or a warning is issued when an analysis program or a sample table is created.

20. An analysis method using the sample data processing device according to claim 2, comprising the steps of:
associating the sample ID information attached to the vial using a marker, with information on a position of the rack for vials;
presenting the two-dimensional image data of the rack for vials captured by the capture device, to an operator; and
selecting a sample to be injected, based on the position in the two-dimensional image data, or the sample ID information and the position information on the rack for vials.

21. An analysis method using the sample data processing device according to claim 2, comprising the steps of:
presenting the two-dimensional image data of the rack for vials in which a marker as a standard sample to be used and another marker as an unknown sample are captured by the image capture unit, to an operator; and
selecting and registering a sample to be injected, based on a position in the two-dimensional image data, or the sample ID information and the position information on the rack for vials, so as to automatically prepare a standard curve from a data on the standard sample and analyze the unknown sample.

22. A sample data processing method comprising the steps of:
capturing a shape of a vial including a marker, using a capture device; and
setting and registering sample information or position information of the vial in terms of the shape of the vial, using a PC or the like, so as to manage the sample.

23. An autosampler, comprising:
a capture device; and
a rack for vials on which one or more vials are disposed,
wherein an injection of a sample can be performed regardless of a size or a shape of the vial or a shape of the rack for vials by: acquiring a position of the vial from a two-dimensional image data of the rack for vials captured by the capture device; linking the acquired position to ID information of the vial; and thereby capturing a position of the vial on the rack for vials.

24. A liquid chromatograph instrument comprising the autosampler according to claim 23.
